(19) United States
(12) Patent Application Publication
(10) Pub. No.: US 2010/0183845 A1
(43) Pub. Date: Jul. 22, 2010

(54) ECO-OPTICAL SHEET

(75) Inventors: Chang Pyo Hong, Yongin-si (KR); Hyo Jin Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC, Gwacheon-si, Gyeonggi-do (KR)

(21) Appl. No.: 12/663,229

(22) PCT Filed: May 28, 2008
(86) PCT No.: PCT/KR08/02991

§ 371 Date: Dec. 4, 2009

(30) Foreign Application Priority Data
Jun. 7, 2007 (KR) 10-2007-0055487
Jul. 6, 2007 (KR) 10-2007-0068113
Dec. 18, 2007 (KR) 10-2007-0133222

(51) Int. Cl. B32B 3/00; C08F 20/10; B32B 27/30; C08F 220/22; C08F 12/24; C08F 28/02

(52) U.S. Cl. 428/156; 526/328; 428/522; 522/182; 526/245; 526/313; 526/286

(57) ABSTRACT

Disclosed is an optical sheet, which is environmentally friendly and has a high refractive index and superior light resistance, and is thus useful for an optical sheet assembly of a backlight unit.

### TECHNICAL FIELD

The present invention relates to an eco-optical sheet, and more particularly, to an optical sheet, which has increased light collection efficiency.

### BACKGROUND ART

As industrial society develops toward an advanced information age, the importance of electronic displays as a medium for displaying and transferring various pieces of information is increasing day by day. Conventionally, a CRT (Cathode Ray Tube), which is bulky, was widely used therefore, but faced considerable limitations in terms of the space required to mount it, thus making it difficult to manufacture CRTs having larger sizes. Accordingly, CRTs are being replaced with various types of flat panel displays, including LCDs, plasma display panels (PDPs), field emission displays (FEDs), and organic electroluminescent displays. Among such flat panel displays, LCDs, a technologically intensive product realized from a combination of liquid crystal-semiconductor techniques, are in particular advantageous because they are slim and lightweight and consume little power. Therefore, research and development into structures and manufacturing techniques thereof is continuing. Further, LCDs, which are already applied in fields such as notebook computers, monitors for desktop computers, and portable personal communication devices (including PDAs and mobile phones), are being manufactured in larger sizes, and thus, it is possible to apply LCDs to large-sized TVs, such as HD (High-Definition) TVs. Thereby, LCDs are receiving attention as novel displays able to substitute for CRTs, which used to be synonymous to ‘displays’.

In the case of LCDs, because the liquid crystals themselves cannot emit light, to realize contrast, an additional light source is provided at the back surface thereof so that the intensity of light passing through the liquid crystals in each pixel is controlled. More specifically, the LCD, serving as a device for adjusting light transmittance using the electrical properties of liquid crystal material, emits light from a light source lamp mounted to the back surface or side surface thereof, and the light thus emitted is passed through various functional optical films or sheets to thus cause light to be uniform and directional, after which such controlled light is also passed through a color filter, thereby realizing red, green, and blue (R, G, B) colors. Furthermore, the LCD is of an indirect light emission type which realizes an image by controlling the contrast of each pixel through an electrical method. As such, a light-emitting device provided with a light source is an important part for determining the quality of the image of the LCD, including luminance and uniformity.

Such a light-emitting device is mainly exemplified by a backlight unit. Typically, a backlight unit emits light using a light source such as a cold cathode fluorescent lamp (CCFL), and such emitted light is sequentially passed through optical sheets including a light guide plate, a diffusion sheet, and a prism sheet, thus reaching a liquid crystal panel.

The light guide plate functions to transfer light emitted from the light source in such a way as to distribute it over the entire front surface of the liquid crystal panel, which is planar. The diffusion sheet plays a role in realizing uniform light intensity over the entire front surface of the screen. The prism sheet is responsible for controlling the light path so that light travelling in various directions through the diffusion sheet is transformed within a range of viewing angles suitable for enabling the image to be viewed by an observer. Further, a reflection sheet is provided under the light guide plate to reflect light, which deviates from the optimal path and does not reach the liquid crystal panel, so that such light is used again, thereby more efficiently using the light source.

In the development of optical sheets constituting the backlight unit, effort is continually made to collect light emitted from the light source and to adjust the direction of light in order to increase front-surface luminance. With the use of three-dimensional (3D) structures able to appropriately change the phenomena of photons, such as interference, diffraction, polarization, etc., based on wave properties and particle properties of light, the light path can be controlled. Further, when physical properties of material forming a 3D structured surface are changed, the light path can be additionally controlled, and thus the photons to be emitted are aligned in a desired direction by a user, thereby increasing luminance in the same direction.

With regard to the formation of a 3D structured surface on an optical sheet, U.S. Pat. Nos. 4,542,449 and 4,906,070 are disclosed.

Further, the key physical properties of the material used for the optical sheet which are relevant to an increase in luminance include the refractive index. As the refractive index is increased, performance of the optical sheet is improved.

Typical examples of resin having a high refractive index, which enables the formation of the 3D structured surface on the optical sheet, include photocurable resin, in which a halogen element such as bromine is contained in the polymer chain thereof.

Moreover, considering recycling obstacles and the problem of pollutants over the entire product lifecycle, from the product design step to production, use, and waste, environmentally friendly product design and cleaner production technology are required to ensure continuous competitiveness and the survival of enterprises.

From the point of view of such trends, the optical sheet having a layer of photocurable resin in which a halogen element such as bromine is substituted in the polymer chain thereof is considered to be unsuitable for meeting environmental regulations.

### DISCLOSURE

### Technical Problem

Accordingly, the present invention provides an optical sheet, which is useful in electrical and electronic products without the generation of harmful components.

In addition, the present invention provides an optical sheet, which does not generate harmful components and exhibits a high refractive index, thus contributing to increased luminance.

In addition, the present invention provides an optical sheet, which does not generate specific harmful components in electrical and electronic products and exhibits a high refractive index, thus contributing to increased luminance.

In addition, the present invention provides an optical sheet including a 3D structured surface, which does not generate specific harmful components in electrical and electronic products and exhibits a high refractive index, thus contributing to increased luminance.

In addition, the present invention provides an optical sheet including a 3D structured surface and a light diffusion layer, which does not generate harmful components in electrical and electronic products and exhibits a high refractive index, thus contributing to increased luminance.

In addition, the present invention provides an optical sheet, which does not generate harmful components and satisfies surface properties able to prevent damage to a 3D structured surface so that it is not affected by external impact when applied to a display.

In addition, the present invention provides an optical sheet, which includes a 3D structured layer satisfying appropriate surface properties, thus facilitating handling thereof.

In addition, the present invention provides an optical sheet, which decreases defective rates and production costs and increases production efficiency.

In addition, the present invention provides an optical sheet having a high refractive index and appropriate surface hardness properties by virtue of adjusting the refractive index and the viscosity in the course of preparation of a liquid composition.

Also, the present invention provides a backlight unit assembly, which does not generate specific harmful components in electrical and electronic products and realizes high luminance.

### Technical Solution

According to a first embodiment of the present invention, an optical sheet may comprise a resin-cured layer, in which an element having 7 valence electrons is absent and which has a refractive index ranging from 1.49 to 1.70 at 25° C. and a structured surface.

The optical sheet according to the present invention may further comprise a substrate layer formed to be in contact with the resin-cured layer.

The optical sheet according to the present invention may further comprise a light diffusion layer formed to be in contact with the resin-cured layer; and a substrate layer.

In the optical sheet according to the present invention, the resin-cured layer may have a refractive index ranging from 1.54 to 1.68 at 25° C.

In the optical sheet according to the present invention, the resin-cured layer may be an acrylate-based photocurable resin-cured layer.

The acrylate-based photocurable resin-cured layer may be formed from a photopolymerizable composition comprising a photocurable acrylate monomer including a cross-linkable derivative; a photoinitiator; and an additive.

Further, the acrylate-based photocurable resin-cured layer may be formed from a photopolymerizable composition including at least one cross-linkable derivative selected from among a fluorene (di)acrylate derivative, a bisphenol (di)acrylate derivative, and a (di)acrylate derivative having a thiol group.

In the optical sheet according to a preferred embodiment of the present invention, the acrylate-based photocurable resin-cured layer may be a resin-cured layer, the resin backbone of which has a repeating unit composed of a fluorene diacrylate derivative represented by Formula 1 below:

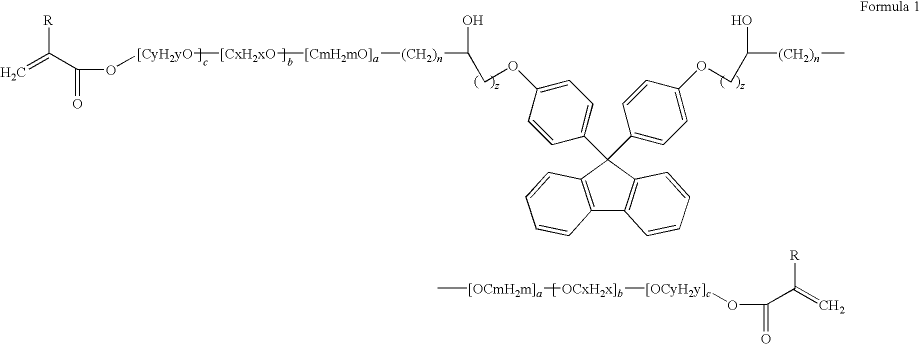

wherein a, b, and c, which are the same as or different from each other, are an integer ranging from 0 to 15, n and z, which are the same as or different from each other, are an integer ranging from 0 to 15, under a condition of a+b+c+n+z≧1, m, x and y, which are the same as or different from each other, are an integer ranging from 0 to 30, in which when a, b and c are not 0, m, x and y which correspond to a, b and c are also not 0, and R is a hydrogen atom or a C₁₋₁₅ alkyl group.

Further, the cross-linkable derivative may comprise a fluorene diacrylate derivative represented by Formula 1 below:

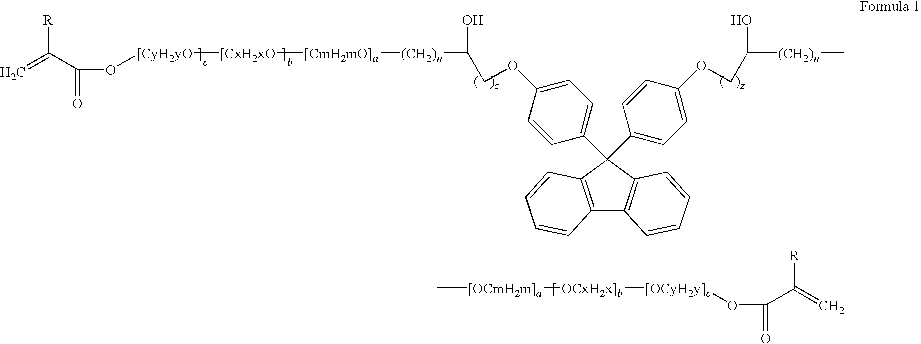

wherein a, b, and c, which are the same as or different from each other, are an integer ranging from 0 to 15, n and z, which are the same as or different from each other, are an integer ranging from 0 to 15, under a condition of a+b+c+n+z≧1, m, x and y, which are the same as or different from each other, are an integer ranging from 0 to 30, in which when a, b and c are not 0, m, x and y which correspond to a, b and c are also not 0, and R is a hydrogen atom or a C₁₋₁₅ alkyl group.

In the optical sheet according to the present invention, the resin-cured layer may have a structured surface in which a plurality of 3D structures is linearly or nonlinearly arranged.

According to a second embodiment of the present invention, an optical sheet may comprise a resin-cured layer formed from a liquid composition comprising a non-halogen cross-linkable derivative and imparted with a structured surface, wherein, when the structured surface is loaded up to a maximum pressure of 1 g_{f} at a loading rate of 0.2031 mN/sec using a flat indenter, held at the maximum pressure for 5 sec, and then unloaded, the optical sheet has a pressure change rate, represented by Equation 1, below, of 40% or more:

$$Pressure Change Rate = \frac{{D}_{1} - {D}_{2}}{{D}_{1}} \times 100 \qquad Equation 1$$

Wherein D₁ is the pressed depth due to the application of external pressure, and D₂ is the difference between the height of the optical sheet before external pressure is applied and the height of the optical sheet returned to an original state after external pressure is removed.

In the optical sheet according to the present invention, the pressure change rate may be 50% or more.

In the optical sheet according to the present invention, the pressure change rate may be 60% or more.

In the optical sheet according to the present invention, the resin-cured layer may be formed from a liquid composition including at least one photocurable acrylate monomer having a viscosity ranging from 1 cps to 50,000 cps at 25° C.

In the optical sheet according to the present invention, the resin-cured layer may have a pencil hardness on its surface of 1H to 3H.

In the optical sheet according to the present invention, the non-halogen cross-linkable derivative may have a refractive index of 1.55 or higher at 25° C.

In the optical sheet according to the present invention, the non-halogen cross-linkable derivative may have a backbone, at least one carbon atom of which is linked with at least two benzene rings and at least one end of which has a cross-linkable unsaturated double bond.

In the optical sheet according to the present invention, the non-halogen cross-linkable derivative may be a fluorene acrylate derivative or a fluorene diacrylate derivative, the backbone of which has a fluorene group.

In the optical sheet according to the present invention, the photocurable acrylate monomer may have a refractive index ranging from 1.44 to 1.55 at 25° C.

In the optical sheet according to the present invention, the liquid composition may have a refractive index of 1.52 or higher at 25° C. and a viscosity ranging from 1 cps to 100,000 cps at 25° C.

In the optical sheet according to the present invention, the resin-cured layer may have a refractive index of 1.54 or higher at 25° C. As such, the resin-cured layer may not contain an element having 7 valence electrons.

The optical sheet according to the present invention may be manufactured by preparing the liquid composition, comprising the photocurable acrylate monomer including the non-halogen cross-linkable derivative and a photoinitiator and having a viscosity ranging from 10 cps to 100,000 cps at 25° C. and a refractive index of 1.52 or higher at 25° C.; applying the liquid composition on a frame engraved with 3D structures; bringing one surface of a transparent substrate film into contact with the surface of the liquid composition applied on the frame, and radiating UV light thereon to cure the liquid composition, thus forming a resin-cured layer; and separating the resin-cured layer from the frame.

In addition, according to an exemplary embodiment of the present invention, a backlight unit assembly may comprise the optical sheet as above.

### ADVANTAGEOUS EFFECTS

According to an embodiment of the present invention, the optical sheet does not contain an element having 7 valence electrons and fulfills a predetermined range requirement of the refractive index, and is thus useful as a part free from harmful components, and further, an electrical and electronic product using the same, in particular, a display product, is considered environmentally friendly. Also, because the optical sheet has a high refractive index, a backlight unit assembly having increased luminance can be provided.

According to another embodiment of the present invention, the optical sheet includes a resin-cured layer formed from a non-halogen cross-linkable derivative, and is thus useful in electrical and electronic products without generation of harmful components. Further, when the optical sheet is applied to a display, it satisfies surface properties able to prevent damage to the structured layer so that it is not affected by external impact, ultimately realizing high luminance. Also, the optical sheet includes the structured layer satisfying appropriate surface properties, thereby facilitating handling thereof, decreasing defective rates and production costs, and increasing production efficiency. In particular, the optical sheet of the present invention is useful as a high-refractive-index optical sheet for increasing the luminance of an optical member.

### DESCRIPTION OF DRAWINGS

FIG. 1 is a schematic view illustrating a pressure change rate; and

FIG. 2 is a schematic view illustrating a process of evaluating scratch resistance.

### BEST MODE

An embodiment of the present invention pertains to an optical sheet, which is environmentally friendly and has a high refractive index. In particular, the optical sheet includes a resin-cured layer, which does not contain an element having 7 valence electrons and has a refractive index of 1.49˜1.70 at 25° C.

Further, the optical sheet according to the embodiment of the present invention includes a resin-cured layer, the surface of which is structured and which does not contain an element having 7 valence electrons and has a refractive index of 1.49˜1.70 at 25° C.

If an optical sheet includes a resin-cured layer containing an element having 7 valence electrons and having a high refractive index, it is difficult to comply with environmental regulations, and further, it is environmentally unfriendly because an environmental hormone is generated therefrom.

Also, in the case where an element having 7 valence electrons is not present but a refractive index is lower than the above range, performance of the optical sheet is deteriorated, making it difficult to increase luminance.

In the case where the resin-cured layer is formed to have a structured surface, it should have a refractive index of 1.54˜1.68 at 25° C. so as to more effectively increase luminance.

When the optical sheet according to the embodiment of the present invention includes the resin-cured layer as mentioned above, it is environmentally harmless and can contribute to an increase in luminance.

The optical sheet according to the embodiment of the present invention, which is environmentally friendly and can further increase front-surface luminance of a display, may be an optical sheet including a resin-cured layer, which does not contain an element having 7 valence electrons and has a refractive index of 1.49˜1.70 at 25° C. and a structured surface, and a substrate layer formed to be in contact with the resin-cured layer.

The substrate layer is a film made of polyethyleneterephthalate, polycarbonate, polypropylene, polyethylene, polystyrene or polyepoxy resin, most effective being a polyethyleneterephthalate film or a polycarbonate film. The thickness thereof is preferably set to a range from about 10 μm to about 1,000 μm to provide excellent mechanical strength, thermal stability, and film flexibility and also to prevent the loss of transmitted light.

In addition, the optical sheet according to the embodiment of the present invention may be an optical sheet including a resin-cured layer, which does not contain an element having 7 valence electrons and has a refractive index of 1.49˜1.70 and a structured surface; a light diffusion layer formed to be in contact with the resin-cured layer; and a substrate layer. This optical sheet may overcome a conventional problems resulting from a plurality of optical sheets being combined, and further, may increase luminance and may control the viewing of bright lines thanks to the structured surface.

The light diffusion layer is formed from a liquid composition obtained by dispersing light-diffusing particles in a binder resin. The refractive index of the light diffusion layer may be lower than that of the resin-cured layer. The binder resin includes a resin that adheres well to the substrate layer and has good compatibility with light-diffusing particles dispersed therein. Particularly useful is a binder resin in which light-diffusing particles are uniformly dispersed so that they are not separated or precipitated out. Examples of the resin include acrylic resin, including homopolymers, copolymers, or terpolymers of unsaturated polyester, methyl methacrylate, ethyl methacrylate, isobutyl methacrylate, n-butyl methacrylate, n-butylmethyl methacrylate, acrylic acid, methacrylic acid, hydroxyethyl methacrylate, hydroxypropyl methacrylate, hydroxyethyl acrylate, acrylamide, methylolacrylamide, glycidyl methacrylate, ethyl acrylate, isobutyl acrylate, n-butyl acrylate, and 2-ethylhexyl acrylate, urethane resin, epoxy resin, and melamine resin.

The light-diffusing particles are used in an amount of 0.0˜1,000 parts by weight, based on 100 parts by weight of the binder resin, so that light diffusion effects are realized and white turbidity and separation of the particles are prevented.

The size of the light-diffusing particles may vary with the thickness of the light diffusion layer. For example, the case where the light-diffusing particles have an average particle size of 0.1˜200 μm is preferable in terms of light diffusion effects and preventing the separation of the particles from the light diffusion layer.

Examples of the light-diffusing particles include various organic and inorganic particles. Typical examples of the organic particles include acrylic particles, including homopolymers or copolymers of methyl methacrylate, acrylic acid, methacrylic acid, hydroxyethyl methacrylate, hydroxypropyl methacrylate, acrylamide, methylolacrylamide, glycidyl methacrylate, ethyl acrylate, isobutyl acrylate, n-butyl acrylate and 2-ethylhexyl acrylate, olefin particles, including polyethylene, polystyrene and polypropylene, acryl-olefin copolymer particles, and multilayer multicomponent particles prepared by forming a layer of homopolymer particles and then forming a layer of another type of monomer thereon, and examples of the inorganic particles include silicon oxide, aluminum oxide, titanium oxide, zirconium oxide, and magnesium fluoride. The above organic and inorganic particles are merely illustrative, are not limited to the examples listed above, and may be replaced with other known materials as long as the main purpose of the present invention is achieved, as will be apparent to those skilled in the art. The case in which the type of material is changed also falls within the technical scope of the present invention.

In the aforementioned optical sheet, the resin-cured layer preferably has a refractive index of 1.54˜1.68 at 25° C. for reasons of light collection efficiency.

The resin-cured layer is favorable because it has film properties without stickiness when dissolved in a solvent and so is free of pollution and is easily reworked. The solvent is exemplified by ethanol, isopropyl alcohol, or acetone.

The film properties may vary depending on the type of polymer resin material for the resin-cured layer. Thus, the resin-cured layer according to the present invention may be an acrylate-based photocurable resin-cured layer. In particular, in order to satisfy the above refractive index requirement, the resin-cured layer may be formed from a photopolymerizable composition composed of a photocurable monomer including a fluorene (di)acrylate derivative, a bisphenol (di)acrylate derivative, or a (di)acrylate monomer having a thiol group as a cross-linkable derivative. Further, in order to realize a high refractive index, the resin-cured layer may be formed from a photopolymerizable composition including a fluorene derivative diacrylate monomer as a photocurable monomer.

A preferred example of the fluorene (di)acrylate derivative is represented by Formula 1 below.

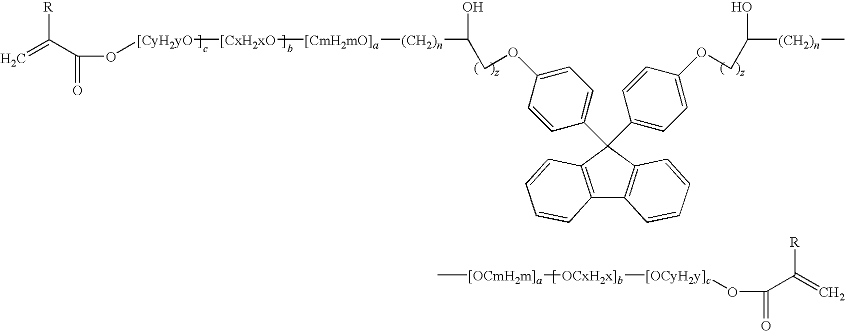

wherein a, b, and c, which are the same as or different from each other, are an integer ranging from 0 to 15, n and z, which are the same as or different from each other, are an integer ranging from 0 to 15, under a condition of a+b+c+n+z≧1, m, x and y, which are the same as or different from each other, are an integer ranging from 0 to 30, in which when a, b and c are not 0, m, x and y which correspond to a, b and c are also not 0, and R is a hydrogen atom or a C₁₋₁₅ alkyl group.

Because the fluorene diacrylate derivative represented by Formula 1 is a high refractive material, the refractive index of the resin-cured layer may be maintained in the range of 1.54˜1.68 after a curing process. Further, the above derivative has superior heat resistance and light resistance and is thus suitable for the formation of the cured layer of the optical sheet.

The amount of the fluorene diacrylate derivative represented by Formula 1 is appropriately adjusted depending on the refractive index or luminance properties necessary for the resin-cured layer, and is set to 5˜99.5 wt %, based on the total amount of the solid content of the photopolymerizable composition, such that luminance is increased.

The photopolymerizable composition for the resin-cured layer is composed mainly of a photocurable acrylate monomer including the cross-linkable derivative, a photoinitiator, and an additive, if necessary.

In addition to the cross-linkable derivative, the acrylate-based photocurable monomer includes, for example, a multifunctional acrylate monomer which has a multifunctional group and thus functions as a cross-linking agent upon photocuring, so that a glass transition temperature is increased and hardness after the curing process is enhanced. Particularly useful is a multifunctional acrylate monomer having an isocyanurate ring, in which the isocyanurate ring has a chemical structure with a delocalized electron density, thus ensuring physical adhesion force dependent on the gradient of electron density, thereby increasing adhesion force after the curing process. More specific examples of the multifunctional acrylate monomer having an isocyanurate ring include tris(hydroxyalkyl) isocyanurate triacrylate monomers, in particular, tris(2-hydroxyethyl)isocyanurate triacrylate.

Further, examples of the other photocurable monomers include tetrahydrofurfuryl acrylate, 2(2-ethoxyethoxy)ethyl acrylate, and 1,6-hexanediol diacrylate. These monomers have the ability to penetrate into fine gaps of the surface of the substrate layer upon curing and thus contribute to increasing the force of adhesion to the substrate layer.

Also, as a monomer for decreasing the viscosity of the composition after a dissolution process, an acrylate monomer having a viscosity of 2,000 cps or less at 25° C., kept within a range that does not deteriorate a refractive index, is included. Specific examples thereof include benzyl (meth)acrylate, phenoxyethyl (meth)acrylate, phenoxypolyethyleneglycol (meth)acrylate, 2-hydroxy-3-phenoxypropyl acrylate, neopentylglycol benzoate acrylate, 2-hydroxy-3-phenoxypropyl acrylate, and phenylphenoxy ethanol acrylate.

The photocurable monomer(s) preferably have a refractive index of 1.44 or higher at 25° C. If the refractive index is too high, the viscosity of the liquid composition is increased and thus the surface hardness of the resin-cured layer is excessively increased. Conversely, if the refractive index is too low, the refractive index of a final optical sheet is decreased, and consequently it is difficult to achieve high luminance. Specifically, the photocurable monomer(s) have a refractive index of 1.44˜1.55 at 25° C.

The viscosity of the liquid composition at 25° C. preferably falls in the range of 10˜100,000, if prepared with or without the use of the photocurable monomer having a viscosity of 1˜50,000 cps at 25° C. and/or a refractive index of 1.44 or higher at 25° C. The viscosity of the liquid composition at 25° C. affects not only process workability but also surface hardness of the resultant resin-cured layer or pressure change rate of the optical sheet. If the viscosity is too high, the resin-cured layer becomes brittle. Conversely, in the case where the viscosity of the liquid composition is too low, the refractive index of the resin-cured layer may be decreased.

Hence, in the case where the photocurable monomer (s) having a viscosity of 150,000 cps at 25° C. are included, it is preferred that the amount thereof be appropriately adjusted in consideration of the viscosity of the liquid composition.

The amount of the photocurable monomer(s) is set such that the total refractive index of the liquid composition is 1.52 or higher. Thereby, the film refractive index of the resin-cured layer after a final curing process becomes more favorable. Specifically, the amount of the photocurable monomer(s) is set such that the total refractive index of the liquid composition is 1.52˜1.68.

Examples of the photocurable monomer(s) under the above restrictions of refractive index or viscosity include, but are not necessarily limited to, tetrahydrofurfuryl acrylate, 2 (2-ethoxyethoxy)ethyl acrylate, 1,6-hexanediol di(meth)acrylate, benzyl (meth)acrylate, phenoxyethyl (meth)acrylate, phenoxypolyethyleneglycol (meth)acrylate, 2-hydroxy-3-phenoxypropyl acrylate, neopentylglycol benzoate acrylate, 2-hydroxy-3-phenoxypropyl acrylate, phenylphenoxyethanol acrylate, caprolactone (meth)acrylate, nonylphenolpolyalkyleneglycol (meth)acrylate, butanediol di(meth)acrylate, bisphenol A polyalkyleneglycol di(meth)acrylate, polyalkyleneglycol di(meth)acrylate, trimethylpropane tri(meth)acrylate, styrene, methylstyrene, phenylepoxy (meth)acrylate, and alkyl (meth)acrylate.

For various reasons, when the liquid composition including the fluorene (di)acrylate derivative as the cross-linkable derivative has a refractive index of 1.52 or higher at 25° C. and a viscosity of 1˜100,000 cps at 25° C., it can satisfy the surface hardness of the resin-cured layer and the pressure change rate and refractive index of the optical sheet. Specifically, the liquid composition has a refractive index of 1.52˜1.68 at 25° C. Examples of the photoinitiator for initiating the photopolymerization of the photocurable monomers include phosphine oxides, propanones, ketones, and formates.

Additionally, the composition for the resin-cured layer may include a UV absorbent so as to prevent the optical sheet from yellowing due to exposure to UV light upon use for a long period of time, if necessary, and examples of the UV absorbent include oxalic anilides, benzophenones, benzotriazines, and benzotriazoles.

Additionally, a UV stabilizer may be included, and examples of the UV stabilizer include hindered amines.

Also, an antistatic agent may be included as an additive.

In the optical sheet according to the embodiment of the present invention, in the case where the film refractive index of the resin-cured layer at 25° C. is 1.54 or higher, an optical sheet which increases luminance may be realized. Specifically, the film refractive index of the resin-cured layer at 25° C. ranges from 1.54 to 1.68.

Further, in order to prevent the generation of harmful components, the optical sheet of the present invention preferably includes a non-halogenated resin layer as the resin-cured layer. Further, a photocurable monomer or additive is selected for environmental reasons.

In addition, the resin-cured layer of the optical sheet of the present invention may have a structured surface in the form of a linear or nonlinear array of a plurality of 3D structures.

In this regard, a method of manufacturing the optical sheet having a structured surface in the form of an array of a plurality of 3D structures according to the present invention includes preparing a liquid composition composed of a photocurable acrylate monomer including a cross-linkable derivative and a photoinitiator; applying the liquid composition on a frame engraved with 3D structures; bringing one surface of a transparent substrate film into contact with the surface of the liquid composition applied on the frame, and radiating UV light thereon to cure the liquid composition, thus forming a resin-cured layer; and separating the resin-cured layer from the frame.

In the preparation of the liquid composition, at least one photocurable monomer having a viscosity of 150,000 cps at 25° C. is used to adjust the viscosity and refractive index of the composition.

In the preparation of the liquid composition including a non-halogen cross-linkable derivative and at least one photocurable monomer having a viscosity of 1˜50,000 cps at 25° C., the refractive index of the liquid composition is set to 1.52 or higher, and the viscosity of the liquid composition is set to 10˜100,000 cps so as to attain a desired pressure change rate and surface hardness of the final optical sheet.

Depending on the shape of the 3D structures of the frame, the shape of the structured surface of the resin-cured layer varies. For example, the structured surface may have a polyhedral shape with a polygonal, semicircular or semi-elliptical cross-section, a columnar shape with a polygonal, semicircular or semi-elliptical cross-section, or a curved columnar shape with a polygonal, semicircular or semi-elliptical cross-section. Further, a combination of one or more of these patterns may be applied. Also, the resin-cured layer may be configured in a form in which one or more concentric circles are arranged when viewed from above, with ridges and valleys formed along the concentric circles.

In addition, another embodiment of the present invention pertains to an optical sheet having a structured surface, which is environmentally friendly and satisfies predetermined surface properties.

Specifically, a resin-cured layer having a structured surface is included, and the resin-cured layer includes a non-halogen cross-linkable derivative as a backbone. In this case, the optical sheet satisfies the following characteristic value. The characteristic value is defined as a pressure change rate represented by Equation 1 below when the structured surface of the resin-cured layer is loaded up to a maximum pressure of 1 g_{f} at a loading rate of 0.2031 mN/sec using a flat indenter, held at the maximum pressure for 5 sec, and then unloaded. It is preferred that the pressure change rate be 40% or more. More preferably, the pressure change rate is 50% or more, still more preferably 60% or more, and most preferably 80% or more.

$$Pressure Change Rate = \frac{{D}_{1} - {D}_{2}}{{D}_{1}} \times 100 \qquad Equation 1$$

wherein D₁ is the pressed depth due to the application of external pressure, and D₂ is the difference between the height of the optical sheet before external pressure is applied and the height of the optical sheet returned to its original state after the external pressure is removed.

In the optical sheet, in particular, an optical sheet having the resin-cured layer imparted with a structured surface, the pressure change characteristic is related to damage to the structured surface attributable to the application of external force when the optical sheet is mounted in a display, and is regarded as an important physical property because it affects the luminance of a display and contributes to increasing productivity or to reducing the production cost upon production of an optical sheet.

Thus, in a preferred embodiment, the optical sheet having the non-halogen cross-linkable derivative backbone is optimized such that it exhibits the pressure change rate, represented by Equation 1, of 40% or more.

If the pressure change rate of the optical sheet is less than 40%, damage to the structured surface may be extremely increased under external impact. As such, damage to the structured surface has an adverse influence on realizing high luminance of a display including the optical sheet, thus making it impossible to show a high-quality image.

A means for achieving such a pressure change characteristic includes a method of appropriately adjusting the refractive index and viscosity in the formation of a liquid composition including a non-halogen cross-linkable derivative. In the liquid composition including the non-halogen cross-linkable derivative, photocurable monomer(s) having a viscosity of 1˜50,000 cps 25° C. are selected, and further, the refractive index, viscosity and amount of the photocurable monomer are adjusted depending on the refractive index and viscosity of the non-halogen cross-linkable derivative so as to satisfy the above pressure change characteristic.

For example, in the case where the non-halogen cross-linkable derivative has a high refractive index, photocurable monomer(s) having a viscosity of 150,000 cps at 25° C., the refractive index of which is somewhat low, may be selected. In this case, the photocurable monomer(s) may be used in an amount smaller than in a typical case. In contrast, photocurable monomer(s) having a refractive index of a predetermined level or higher may be selected. In this case, the photocurable monomer(s) may be used in an amount larger than in a typical case.

Further, in the optical sheet according to the embodiment of the present invention, satisfying the above pressure change characteristic, the resin-cured layer having a structured surface has a pencil hardness on its surface of 1H-3H. If the surface hardness is too large, damage to the structured surface may be prevented, but flexibility is decreased, and also, in the subsequent course of assembling another film on the structured surface, the back surface of the film may be damaged.

In the case where the non-halogen cross-linkable derivative is a high refractive resin satisfying a refractive index of a predetermined level or higher, it typically has a high viscosity. If the viscosity thereof is not adjusted in the event of combination with the photocurable monomer, a very hard resin-cured layer falling outside of the above surface hardness range may result. Thus, in order to achieve such a surface hardness value, the viscosity of the liquid composition including the non-halogen cross-linkable derivative and the photocurable monomer must be adjusted.

To be usable in the formation of the resin-cured layer in the present invention, the non-halogen cross-linkable derivative must have a refractive index of 1.55 or higher at 25° C. in order to obtain a resin-cured layer having a high refractive index. Ultimately, the optical sheet has a high refractive index and thus high luminance thereof can be realized.

In addition, the non-halogen cross-linkable derivative, which may satisfy or not the above refractive index, has a backbone, at least one carbon atom of which is linked with at least two benzene rings and at least one end of which has a cross-linkable unsaturated double bond.

Because two or more benzene rings are linked to the derivative backbone, a refractive index of an appropriate level or higher may be exhibited. Further, the above derivative has a tendency of increasing the refractive index in proportion to an increase in the number of benzene rings.

Particularly, the non-halogen cross-linkable derivative may be a fluorene acrylate derivative or a fluorene diacrylate derivative, having a fluorene group in the backbone thereof.

In the description above and below, the term ‘non-halogen cross-linkable derivative’ is defined as a cross-linkable monomer or oligomer, which does not contain a halogen element, in particular, bromine, and has an end group able to cause a cross-linking reaction due to the radiation of UV light.

In the optical sheet of the present invention, the photocurable monomer(s) for the resin-cured layer have a refractive index of 1.44 or higher at 25° C., and preferably a refractive index of 1.44˜1.55 at 25° C.

The liquid composition including the non-halogen cross-linkable derivative preferably has a viscosity of 10˜100,000 at 25° C., whether prepared with or without the use of the photocurable monomer having a viscosity of 1˜50,000 cps at 25° C. and/or a refractive index of 1.44 or higher at 25° C. The viscosity of the liquid composition at 25° C. affects not only process workability but also surface hardness of the resultant resin-cured layer or pressure change rate of the optical sheet. If the viscosity is too high, the resin-cured layer becomes brittle. Conversely, if the viscosity of the liquid composition is too low, the refractive index of the resin-cured layer may be decreased.

Hence, in the case where the photocurable monomer(s) having a viscosity of 1˜50,000 cps at 25° C. are included, the amount thereof is appropriately adjusted in consideration of the viscosity of the liquid composition.

The amount of the photocurable monomer(s) is set such that the total refractive index of the liquid composition is 1.52 or higher. Thereby, the film refractive index of the resin-cured layer after a final curing process becomes more favorable. Specifically, the amount of the photocurable monomer(s) is set such that the total refractive index of the liquid composition is 1.52˜1.68.

When the photocurable monomer(s) are selected taking into account the refractive index and viscosity as mentioned above, a specific example of the compound thereof may vary in consideration of the structural properties of the non-halogen cross-linkable derivative. For example, if the non-halogen cross-linkable derivative is a fluorene diacrylate derivative having a fluorene group, examples of the photocurable monomer include tetrahydrofurfuryl acrylate, 2(2-ethoxyethoxy)ethyl acrylate, 1,6-hexanediol di(meth)acrylate, benzyl (meth)acrylate, phenoxyethyl (meth)acrylate, phenoxypolyethyleneglycol (meth)acrylate, 2-hydroxy-3-phenoxypropyl acrylate, neopentylglycol benzoate acrylate, 2-hydroxy-3-phenoxypropyl acrylate, phenylphenoxyethanol acrylate, caprolactone (meth)acrylate, nonylphenolpolyalkyleneglycol (meth)acrylate, butanediol di(meth)acrylate, bisphenol A polyalkyleneglycol di(meth)acrylate, polyalkyleneglycol di(meth)acrylate, trimethylpropane tri(meth)acrylate, styrene, methylstyrene, phenylepoxy (meth)acrylate, and alkyl (meth)acrylate.

For various reasons, when the liquid composition including the non-halogen cross-linkable compound has a refractive index of 1.52 or higher at 25° C. and a viscosity of 1˜100,000 cps at 25° C., the surface hardness of the resin-cured layer and the pressure change rate and refractive index of the optical sheet can be satisfied. Specifically, the liquid composition has a refractive index of 1.52˜1.68 at 25° C.

The liquid composition for the resin-cured layer may include a photoinitiator for initiating the photopolymerization of the non-halogen cross-linkable derivative or photocurable monomers. Examples of the photoinitiator include, but are not limited to, phosphine oxides, propanones, ketones, and formates.

Further, the liquid composition may include an additive, if necessary, and examples of the additive include, but are not limited to, a UV absorbent and a UV stabilizer.

The optical sheet according to the embodiment of the present invention may be useful as an optical sheet which increases in luminance as long as the resin-cured layer thereof has a film refractive index of 1.54 or higher at 25° C. Specifically, the resin-cured layer has a film refractive index of 1.54˜1.68 at 25° C. In particular, with the goal of preventing the generation of harmful components, the resin-cured layer of the optical sheet of the present invention is a non-halogenated resin layer. In consideration thereof, a photocurable monomer or additive is selected out of environmental considerations.

A method of manufacturing the optical sheet according to the embodiment of the present invention includes preparing a liquid composition, which is composed of a photocurable acrylate monomer including a non-halogen cross-linkable derivative and a photoinitiator and thus has a viscosity of 10˜100,000 cps and a refractive index of 1.52 or higher; applying the liquid composition on a frame engraved with 3D structures; bringing one surface of a transparent substrate film into contact with the surface of the liquid composition applied on the frame, and radiating UV light thereon to cure the liquid composition, thus forming a resin-cured layer; and separating the resin-cured layer from the frame.

In the preparation of the liquid composition, at least one photocurable monomer having a viscosity of 1˜50,000 cps at 25° C. is used, thus adjusting the viscosity and refractive index of the liquid composition.

When the liquid composition including the non-halogen cross-linkable derivative and at least one photocurable monomers having a viscosity of 1˜50,000 cps at 25° C. is prepared, the refractive index of the liquid composition is adjusted to 1.52 or higher and the viscosity of the liquid composition is adjusted to 10˜100,000 cps so as to attain a desired pressure change rate and surface hardness of the final optical sheet.

In the course of the preparation of the liquid composition, in addition to considerations of the refractive index and viscosity, other process properties are controlled so that the pressure change rate of a final optical sheet is 40% or more, thereby preventing a decrease in luminance due to damage to the resin-cured layer, facilitating handling thereof, and improving productivity. The optical sheet is controlled such that the pressure change rate thereof is preferably 50% or more, more preferably 60% or more, and most preferably 80% or more.

### MODE FOR INVENTION

A better understanding of the present invention may be obtained through the following examples, which are set forth to illustrate, but are not to be construed as the limit of the present invention.

### Example 1

100 parts by weight of 9,9-bis[4-(2-acryloyloxyethoxy)phenyl]fluorene, 20 parts by weight of tris(2-hydroxyethyl)isocyanurate triacrylate, 3 parts by weight of 1,6-hexanediol diacrylate, 63 parts by weight of phenoxyethyl acrylate, 6 parts by weight of 2,4,6-trimethylbenzoyl diphenyl phosphine oxide, 3.6 parts by weight of 2(2-hydroxy-5-t-octoxybenzotriazole), and 3 parts by weight of bis(1,2,2,6,6-pentamethyl-4-piperidyl)sebacate were mixed, thus preparing a composition for a resin-cured layer.

The composition for a resin-cured layer was placed along with a polyethyleneterephthalate (PET) film having a thickness of 125 μm in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

### Example 2

39 parts by weight of epoxy acrylate (CN120, available from Sartomer), 39 parts by weight of ethoxylated bisphenol A diacrylate (SR-349, available from Sartomer), 7.5 parts by weight of 1,6-hexanediol diacrylate (SR-238, available from Sartomer), 11.5 parts by weight of tris(2-hydroxyethyl)isocyanurate triacrylate (SR-368, available from Sartomer), and 3 parts by weight of 2,4,6-trimethylbenzoyl diphenyl phosphine oxide (Darocure TPO, available from CIBA) as a photoinitiator were mixed, thus preparing a composition for a resin-cured layer.

The composition for a resin-cured layer was placed along with a PET film having a thickness of 125 μm in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

### Example 3

100 parts by weight of acrylic resin (52-666, available from Aekyung Chemical) was diluted with 100 parts by weight of methylethylketone and 100 parts by weight of toluene, thus preparing a binder resin, to which spherical polymethylmethacrylate particles (MH20F, available from KOLON) having an average particle size of 20 μm were added in an amount of 130 parts by weight based on the binder resin, and then dispersed using a milling machine.

The liquid composition thus obtained was applied on one surface of a PET film (T600, available from Mitsubishi) having a thickness of 125 μm using a gravure coater, cured at 120° C. for 60 sec, and then dried, thus forming a light diffusion layer having a dry thickness of 23 μm.

Separately, 100 parts by weight of 9,9-bis[4-(2-acryloyloxyethoxy)phenyl]fluorene, 20 parts by weight of tris(2-hydroxyethyl)isocyanurate triacrylate, 3 parts by weight of 1,6-hexanediol diacrylate, 63 parts by weight of phenoxyethyl acrylate, 6 parts by weight of 2,4,6-trimethylbenzoyl diphenyl phosphine oxide, 3.6 parts by weight of 2(2-hydroxy-5-t-octoxybenzotriazole), and 3 parts by weight of bis(1,2,2,6,6-pentamethyl-4-piperidyl)sebacate were mixed, thus preparing a composition for a resin-cured layer.

Thereafter, the PET film 125 μm thick having the light diffusion layer formed thereon and the composition for a resin-cured layer were placed in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

### Example 4

100 parts by weight of acrylic resin (52-666, available from Aekyung Chemical) was diluted with 100 parts by weight of methylethylketone and 100 parts by weight of toluene, thus preparing a binder resin, to which spherical polymethylmethacrylate particles (MH20F, available from KOLON) having an average particle size of 20 μm were added in an amount of 130 parts by weight based on the binder resin, and then dispersed using a milling machine.

The liquid composition thus obtained was applied on one surface of a PET film (T600, available from Mitsubishi) having a thickness of 125 μm using a gravure coater, cured at 120° C. for 60 sec, and then dried, thus forming a light diffusion layer having a dry thickness of 23 μm.

Separately, 39 parts by weight of epoxy acrylate (CN120, available from Sartomer), 39 parts by weight of ethoxylated bisphenol A diacrylate (SR-349, available from Sartomer), 7.5 parts by weight of 1,6-hexanediol diacrylate (SR-238, available from Sartomer), 11.5 parts by weight of tris(2-hydroxyethyl)isocyanurate triacrylate (SR-368, available from Sartomer), and 3 parts by weight of 2,4,6-trimethylbenzoyl diphenyl phosphine oxide (Darocure TPO, available from CIBA) as a photoinitiator were mixed, thus preparing a composition for a resin-cured layer.

Thereafter, the PET film 125 μm thick having the light diffusion layer formed thereon and the composition for a resin-cured layer were placed in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

### Comparative Example 1

40 parts by weight of brominated epoxy diacrylate (RDX 51027, available from UCB), 30 parts by weight of hexafunctional urethane acrylate (EB220, available from UCB), 27 parts by weight of benzyl methacrylate (available from Kongyoungsa), and 3 parts by weight of 2,4,6-trimethylbenzoyl diphenyl phosphine oxide (Darocure TPO, available from CIBA) as a photoinitiator were mixed, thus preparing a composition for a resin-cured layer.

Thereafter, the composition for a resin-cured layer was placed along with a PET film having a thickness of 125 μm in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

### Comparative Example 2

100 parts by weight of acrylic resin (52-666, available from Aekyung Chemical) was diluted with 100 parts by weight of methylethylketone and 100 parts by weight of toluene, thus preparing a binder resin, to which spherical polymethylmethacrylate particles (MH20OF, available from KOLON) having an average particle size of 20 μm were added in an amount of 130 parts by weight based on the binder resin, and then dispersed using a milling machine.

The liquid composition thus obtained was applied on one surface of a PET film (T600, available from Mitsubishi) having a thickness of 125 μm using a gravure coater, cured at 120° C. for 60 sec, and then dried, thus forming a light diffusion layer having a dry thickness of 23 μm.

Separately, 40 parts by weight of brominated epoxy diacrylate (RDX 51027, available from UCB), 30 parts by weight of hexafunctional urethane acrylate (EB220, available from UCB), 27 parts by weight of benzyl methacrylate (available from Kongyoungsa), and 3 parts by weight of 2,4,6-trimethylbenzoyl diphenyl phosphine oxide (Darocure TPO, available from CIBA) as a photoinitiator were mixed, thus preparing a composition for a resin-cured layer.

Thereafter, the PET film 125 μm thick having the light diffusion layer formed thereon and the composition for a resin-cured layer were placed in a cylindrical mold (engraved with a linear array of triangular prisms having an isosceles triangular cross-section with a vertex of 90°, a base of 50 μm, and a height of 25 μm), and then UV light of 50˜500 mJ/m² (600 W/inch, D bulb, available from Fusion) was radiated thereon, thus performing a curing process, after which a separation process from the mold was conducted, thereby obtaining an optical sheet.

The refractive index of the resin-cured layer and the force of adhesion of the resin-cured layer to the substrate layer of the optical sheets of Examples 1 to 4 and the Comparative Examples 1 and 2 were measured. Further, the luminance of the optical sheet was measured. The results are shown in Table 1 below.

Furthermore, through the elemental analysis of the resin-cured layer, detection for an element having 7 valence electrons was evaluated. The quantitative results are shown in Tables 2 to 7 below.

Specific measurement methods used are described below.

(1) Refractive Index of Resin-Cured Layer: In order to evaluate the refractive index of the cured composition, the composition was applied on a PET film, a metal plate having a smooth surface was placed thereon, and then pressure was applied thereto such that the total thickness was 20 μm. Thereafter, using an electrodeless UV radiation system (600 W/inch, available from Fusion, USA) provided with a Type-D bulb, energy of 700 mJ/cm² was radiated onto the outer surface of the PET film, and then the metal plate was separated. The refractive index of the composition cured on the PET film was measured using a refractometer (model number: IT, available from ATAGO ABBE, Japan). The light source for measurement was a sodium D-line lamp at 589.3 nm. The refractive index was measured at 25° C.

(2) Adhesion Force (No. of Detached Matrix Pieces/100): The composition for a resin-cured layer of each of Examples 1 and 2 and Comparative Examples 1 and 2 was applied on a transparent PET film, a metal plate having a smooth surface was placed thereon, and then pressure was applied thereto such that the total thickness was 3 μm. Thereafter, a curing process was performed, the metal plate was removed, and then only the cured layer having a predetermined thickness was cut to 100 matrix pieces in the area of 10 mm×10 mm, after which tape was attached thereon and was then detached perpendicular to the attachment surface under strong force, followed by counting the number of detached matrix pieces.

(3) Luminance

Two optical sheets of each of Examples 1 to 4 and Comparative Examples 1 and 2 were mounted perpendicular to each other to a backlight unit (model number: LM170E01, available from Heesung Electronics, Korea) for 17″ LCD panels, and the luminance values of 13 random points were measured using a luminance meter (model number: BM-7, available from TOPCON, Japan), and then averaged.

(4) Elemental Analysis: The elemental analysis was conducted using ion chromatography.

TABLE 1

| | Ex. 1 | Ex. 2 | Ex. 3 | Ex. 4 | C. Ex. 1 | C. Ex. 2 |
|---|---|---|---|---|---|---|
| Refractive Index of Resin- | 1.6054 | 1.5305 | 1.6061 | 1.5316 | 1.5510 | 1.5521 |
| Cured Layer (25° C.) | | | | | | |
| Adhesion Force | 100/100 | 100/100 | 100/100 | 100/100 | 99/100 | 100/100 |
| Luminance (Cd/m²) | 3051 | 2121 | 3086 | 2140 | 2698 | 2705 |

As is apparent from Table 1, the optical sheets having the resin-cured layer satisfying a predetermined range requirement of the refractive index without containing an element having 7 valence electrons, achieved appropriate luminance. Further, after the curing process, the force of adhesion of the resin-cured layer to the substrate layer was seen to be superior.

TABLE 2
Example 1 (Quantitative Result)

| Analyte | Result | Proc-Cal | Line | Net Int. | BG Int. |
|---|---|---|---|---|---|
| Ni | 0.0308% | Quant.-FP | Nika | 70.531 | 5.372 |
| C | 99.9692% | Balance | | | |

TABLE 3
Example 2 (Quantitative Result)

| Analyte | Result | Proc-Cal | Line | Net Int. | BG Int. |
|---|---|---|---|---|---|
| Ni | 0.0161% | Quant.-FP | Nika | 37.141 | 5.227 |
| C | 99.9839% | Balance | | | |

TABLE 4
Example 3 (Quantitative Result)

| Analyte | Result | Proc-Cal | Line | Net Int. | BG Int. |
|---|---|---|---|---|---|
| Ni | 0.0234% | Quant.-FP | Nika | 53.771 | 5.414 |
| C | 99.9766% | Balance | | | |

TABLE 5
Example 4 (Quantitative Result)

| Analyte | Result | Proc-Cal | Line | Net Int. | BG Int. |
|---|---|---|---|---|---|
| Ni | 0.0222% | Quant.-FP | Nika | 50.885 | 5.289 |
| C | 99.9778% | Balance | | | |

TABLE 6
Comparative Example 1 (Quantitative Result)

| Analyte | Result | Proc-Cal | Line | Net Int. | BG Int. |
|---|---|---|---|---|---|
| Br | 0.8445% | Quant.-FP | BrKa | 3406.484 | 38.035 |
| Ni | 0.0121% | Quant.-FP | NiKa | 25.663 | 4.592 |
| C | 99.1434% | Balance | | | |

TABLE 7
Comparative Example 2 (Quantitative Result)

| Analyte | Result | Proc-Cal | Line | Net Int. | BG Int. |
|---|---|---|---|---|---|
| Br | 1.1192% | Quant.-FP | BrKa | 4118.131 | 39.341 |
| Ni | 0.0151% | Quant.-FP | NiKa | 30.904 | 4.437 |
| C | 98.8657% | Balance | | | |

### Examples 5 to 21 and Reference Examples 1 and 2

A photopolymerizable composition was prepared using the composition and composition ratio of each of Tables 8 to 10 below, and was then applied using a known method onto a frame engraved with 3D structures (prism layer) having the function of increasing luminance. In a state in which one surface of a transparent substrate film (PET film) was brought into contact with the coated surface of the frame, UV light was radiated onto the outer surface of the transparent substrate film, thus photocuring the composition which had been applied onto the frame. The coating layer adhered to and cured on the transparent substrate film was separated from the frame, thereby manufacturing a prism film in which a resin-cured layer was formed on one surface of the transparent substrate film.

As the UV radiation system, an electroless UV radiation system (600 W/inch, available from Fusion, USA) provided with a Type-D bulb was used, and thus UV light of 900 mJ/cm² was radiated.

As shown in Tables 8 to 10 below, a liquid composition composed of a cross-linkable compound represented by Formula 1 as a photocurable monomer and a photoinitiator was formulated. However, this is merely illustrative to show the refractive index depending on the type of compound represented by Formula 1, and the liquid composition may include other known components and additives, as will be apparent to those skilled in the art.

The evaluation methods for these examples are described below.

(1) Refractive Index of Composition

The refractive index of the composition was measured using a refractometer (model number: IT, available from ATAGO ABBE, Japan). The light source for measurement was a sodium D-line lamp at 589.3 nm. As such, the refractive index was measured at 25° C.

(2) Film Refractive Index after Curing

In order to measure the refractive index of the composition after a curing process, the composition was applied on a PET film, a metal plate having a smooth surface was placed thereon, and then pressure was applied thereto such that the total thickness was 20 μm. Thereafter, using an electrodeless UV radiation system (600 W/inch, available from Fusion, USA) provided with a Type-D bulb, energy of 700 mJ/ad was radiated onto the outer surface of the PET film, and then the metal plate was separated therefrom. The refractive index of the composition cured on the PET film was measured using a refractometer (model number: IT, available from ATAGO ABBE, Japan). The light source for measurement was a sodium D-line lamp at 589.3 nm. As such, the refractive index was measured at 25° C.

TABLE 8

| | | Ex. 5 | Ex. 6 | Ex. 7 | Ex. 8 | Ex. 9 | Ex. 10 | Ex. 11 | Ex. 12 | Ref. Ex. 1 |
|---|---|---|---|---|---|---|---|---|---|---|
| Photocurable | Compound of | a, b, | a = 1, | a = 2, | a = 3, | a = 5, | a = 8, | a = 10, | a = 15, | a = 16, |
| Monomer (wt %) | Formula 1 | c = 0, | b, c = 0, | b, c = 0, | b, c = 0, | b, c = 0, | b, c = 0, | b, c = 0, | b, c = 0, | b, c = 0, |
| | | n, z = 1 | m = 2, | m = 2, | m = 2, | m = 2, | m = 2, | m = 2, | m = 2, | m = 2, |
| | | | n, z = 1 | n, z = 1 | n, z = 1 | n, z = 1 | n, z = 1 | n, z = 1 | n, z = 1 | n, z = 1 |
| | Amount (wt %) | 99.5 | 99.5 | 99.5 | 99.5 | 99.5 | 99.5 | 99.5 | 99.5 | 99.5 |

| | | | | | | | | | |
|---|---|---|---|---|---|---|---|---|---|
| Photoinitiator (wt %) | 0.5 | 0.5 | 0.5 | 0.5 | 0.5 | 0.5 | 0.5 | 0.5 | 0.5 |
| Refractive Index of | 1.618 | 1.598 | 1.581 | 1.568 | 1.551 | 1.535 | 1.520 | 1.515 | 1.509 |
| Liquid Composition (25° C.) | | | | | | | | | |
| Film Refractive Index (25° C.) | 1.644 | 1.632 | 1.614 | 1.593 | 1.579 | 1.560 | 1.545 | 1.540 | 1.532 |

* Photoinitiator: 2,4,6-trimethylbenzoyl diphenyl phosphine oxide

In Examples 5 to 12 and Reference Example 1, as the number of ethyleneglycol chains of the compound of Formula 1 was increased, the refractive index thereof was somewhat decreased. Further, the case where the number of chains was greater than 15 resulted in the film refractive index outside of the range of 1.54.

TABLE 9

| | | Ex. 6 | Ex. 13 | Ex. 14 | Ex. 15 | Ex. 16 | Ex. 17 | Ex. 18 | Ref. Ex. 2 |
|---|---|---|---|---|---|---|---|---|---|
| Photocurable | Compound of | a = 1, | a = 1, | a = 1, | a = 1, | a = 1, | a = 1, | a = 1, | a = 1, |
| Monomer (wt %) | Formula 1 | b, c = 0, | b, c = 0, | b, c = 0, | b, c = 0, | b, c = 0, | b, c = 0, | b, c = 0, | b, c = 0, |
| | | m = 2, | m = 3, | m = 4, | m = 15, | m = 20, | m = 25, | m = 30, | m = 31, |
| | | n, z = 1 | n, z = 1 | n, z = 1 | n, z = 1 | n, z = 1 | n, z = 1 | n, z = 1 | n, z = 1 |
| | Amount (wt %) | 99.5 | 99.5 | 99.5 | 99.5 | 99.5 | 99.5 | 99.5 | 99.5 |

| | | | | | | | | |
|---|---|---|---|---|---|---|---|---|
| Photoinitiator (wt %) | 0.5 | 0.5 | 0.5 | 0.5 | 0.5 | 0.5 | 0.5 | 0.5 |
| Refractive Index of | 1.598 | 1.588 | 1.581 | 1.540 | 1.535 | 1.525 | 1.518 | 1.510 |
| Liquid Composition (25° C.) | | | | | | | | |
| Film Refractive Index (25° C.) | 1.632 | 1.613 | 1.606 | 1.566 | 1.561 | 1.550 | 1.543 | 1.534 |

* Photoinitiator: 2,4,6-trimethylbenzoyl diphenyl phosphine oxide

As is apparent from the results of Examples 6, 13 to and Reference Example 2, in the fluorene diacrylate derivative represented by Formula 1, the case where m was 30 or less was seen to be more favorable in terms of a high refractive index.

TABLE 10

| | | Ex. 19 | Ex. 20 | Ex. 21 |
|---|---|---|---|---|
| Photocurable | Compound of | a, b = 1, c = 0, | a, b, c = 1, | a, b, c = 1, |
| Monomer | Formula 1 | m = 2, x = 3, | m = 2, x = 3, y = 4, | m = 3, x = 4, y = 10, |
| | | y = 0, n, z = 1 | n = 1, z = 1 | n = 1, z = 1 |
| | Amount (wt %) | 99.5 | 99.5 | 99.5 |

| | | | |
|---|---|---|---|
| Photoinitiator (wt %) | 0.5 | 0.5 | 0.5 |
| Refractive Index of Liquid | 1.575 | 1.557 | 1.540 |
| Composition (25° C.) | | | |
| Film Refractive Index | 1.598 | 1.583 | 1.565 |
| (25° C.) | | | |

* Photoinitiator: 2,4,6-trimethylbenzoyl diphenyl phosphine oxide

As is apparent from the results of Examples 19 to 21, even in the case of the photopolymerizable composition including the fluorene diacrylate derivative added with various alkylene groups, a high refractive index was realized.

### Example 22

A non-halogen cross-linkable derivative and a photocurable acrylate monomer, satisfying the properties shown in Table 11 below, were mixed with a photoinitiator at 50° C. for 3 hours, thus preparing a liquid composition for a resin-cured layer, satisfying the properties of Table 11 below.

The refractive index of each of the components constituting the liquid composition and the refractive index of the liquid composition were measured using a refractometer (model number: IT, available from ATAGO ABBE, Japan). The light source for measurement was a sodium D-line lamp at 589.3 nm.

Further, the viscosity was measured using a Brookfield viscometer.

The liquid composition was applied on one surface of a PET film (thickness: 188 μm) as a substrate layer, the frame of a prism-shaped roller at 50° C. was coated therewith, and then UV light was radiated at 900 mJ/cm² using a UV radiation system (600 W/inch, available from Fusion) provided with a Type-D bulb, thus forming linear triangular prisms having a vertex of 90°, a pitch of 50 μm, and a height of 28 μm, thereby manufacturing an optical sheet.

The refractive index of the prism layer of the optical sheet thus obtained was measured. The results are shown in Table 11 below. The refractive index of the prism layer was measured using a refractometer (model number: IT, available from ATAGO ABBE, Japan).

Further, the pressure change rate of the optical sheet was measured through a load-unload test using an ultra-micro hardness tester (DUH-W201S, available from Shimadzu, Japan).

Specific measurement conditions were as follows.

a. Maximum Pressure: 1 g_{f} (=9.807 mN)

b. Pressure per Unit Time: 0.2031 mN/sec

c. Holding Time at Maximum Pressure: 5 sec

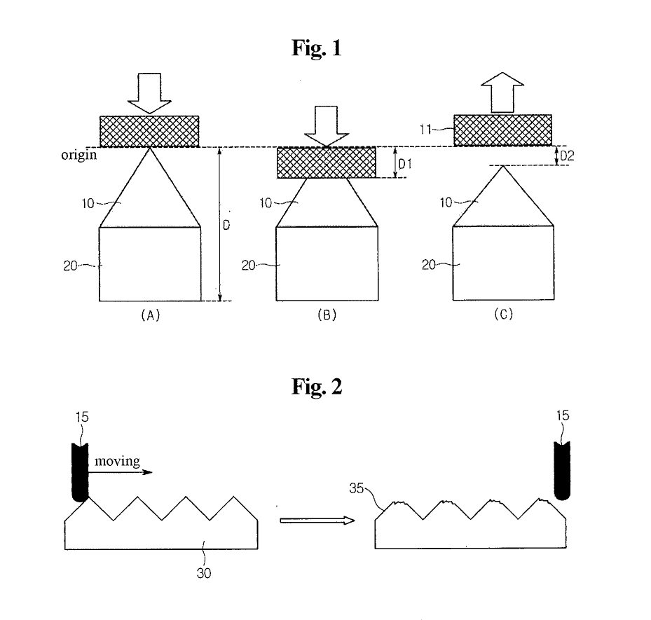

The process of measuring the pressure change rate is illustrated in FIG. 1. When force is applied to the structured layer 10 of the optical sheet using a flat indenter 11, the upper surface of the structured layer 10 is pressed, as shown in (B). The pressed depth is referred to as D₁.

Thereafter, when the flat indenter 11 is removed, the upper surface of the structured layer 10 is returned as close as possible to its original state without damage, as shown in (C). As such, the difference between the height of the optical sheet returned to an original state and the height D of the optical sheet before external pressure is applied is referred to as D₂.

In order to increase the pressure change rate, when D₁ is large and D₂ is small, the material for the optical sheet is elastic so that the optical sheet is returned as close as possible to its original height. Also, when D₁ is small and D₂ is small, superior surface hardness may result.

The surface hardness of the resin-cured layer was measured. The results are shown in Table 11 below. The surface hardness was measured through a pencil hardness measurement method.

TABLE 11

| | | Refractive | Viscosity | Liquid | Liquid | Liquid | Liquid | Liquid |
|---|---|---|---|---|---|---|---|---|
| | | Index at | at 25° C. | Composit. | Composit. | Composit. | Composit. | Composit. |
| | | 25° C. | (cps) | 1 | 2 | 3 | 4 | 5 |
| Non-Halogen | a | 1.62 | 160,000 | 80 | 10 | — | 44 | 40 |
| Cross-linkable | b | 1.55 | 300,000 | — | — | 70 | — | 49 |
| Derivative | | | | | | | | |
| Photocurable | a | 1.45 | 15 | 5 | — | — | 55 | — |
| Monomer | b | 1.51 | 20 | 14 | — | — | — | — |
| | c | 1.53 | 140 | — | — | 29 | — | — |
| | d | 1.54 | 40,000 | — | 89 | — | — | 10 |

| | | | | | | | |
|---|---|---|---|---|---|---|---|
| Photoinitiator (2,4,6- | — | — | 1 | 1 | 1 | 1 | 1 |
| trimethylbenzoyl | | | | | | | |
| diphenylphospineoxide) | | | | | | | |
| Refractive Index of | — | — | 1.59 | 1.56 | 1.54 | 1.52 | 1.57 |
| Liquid Composition at | | | | | | | |
| 25° C. | | | | | | | |
| Viscosity of Liquid | — | — | 800 | 90,000 | 4,000 | 100 | 150,000 |
| Composition at 25° C. | | | | | | | |
| (cps) | | | | | | | |
| Refractive Index of | — | — | 1.61 | 1.58 | 1.56 | 1.54 | Production |
| Resin-Cured Layer at | | | | | | | Impossible |
| 25° C. | | | | | | | |
| Pressure Change Rate | — | — | 80% | 65% | 45% | 35% | |
| of Optical Sheet (%) | | | | | | | |
| Surface Hardness of | — | — | 2H | 3H | H | 5H | |
| Resin-Cured Layer | | | | | | | |

Note:
Non-Halogen Cross-linkable Derivative:
a - 9,9-Bis[4-(2-acryloyloxyepoxy)phenyl]fluorene
b - Bisphenol A epoxy diacrylate (PE210, available from MIWON)
Photocurable Monomer:
a - Hexanediol diacrylate
b - Benzyl acrylate
c - Phenyl epoxy acrylate
d - Fatty acid modified epoxy acrylate (Mirammer PE-240)

As is apparent from Table 11, the amount of the liquid composition is represented by a percentage, namely wt %, based on the total weight of the liquid composition.

### Experimental Example

Minimum pressure was applied to respective optical sheets obtained in Example 22 using a standard weight of a Big Heart tester, available from IMOTO, after which whether the structured layer was scratched was observed. The results are shown in Table 12 below. The degree of damage was observed with the naked eye and was then evaluated according to the following.

Respective optical sheets obtained from the liquid compositions 1 to 5 are referred to as optical sheets 1 to 5.

Poor scratch resistance←x<Δ<◯<⊚→good scratch resistance

TABLE 12

| | Optical | Optical | Optical | Optical | Optical |
|---|---|---|---|---|---|
| | Sheet 1 | Sheet 2 | Sheet 3 | Sheet 4 | Sheet 5 |
| Scratch | ⊚ | ◯ | ◯ | X | Production |
| Resistance | | | | | Impossible |

As is apparent from the results of Table 12, when the optical sheets, including the resin-cured layer formed from the liquid composition composed of the non-halogen cross-linkable derivative and the photocurable monomer having a viscosity of 1˜50,000 cps at 25° C., exhibited the pressure change rate of 40% or more (optical sheets 1 to 3), they could be seen to appropriately resist to scratches.

1. An optical sheet, comprising a resin-cured layer, in which an element having 7 valence electrons is absent and which has a refractive index ranging from 1.49 to 1.70 and a structured surface.

2. The optical sheet according to claim 1, further comprising a substrate layer formed to be in contact with the resin-cured layer.

3. The optical sheet according to claim 1, further comprising a light diffusion layer formed to be in contact with the resin-cured layer; and a substrate layer.

4. The optical sheet according to claim 1, wherein the resin-cured layer has a refractive index ranging from 1.54 to 1.68.

5. The optical sheet according to claim 1, wherein the resin-cured layer is an acrylate-based photocurable resin-cured layer.

6. The optical sheet according to claim 5, wherein the acrylate-based photocurable resin-cured layer is formed from a photopolymerizable composition comprising a photocurable acrylate monomer including a cross-linkable derivative; a photoinitiator; and an additive.

7. The optical sheet according to claim 5, wherein the acrylate-based photocurable resin-cured layer is formed from a photopolymerizable composition including at least one cross-linkable derivative selected from among a fluorene (di)acrylate derivative, a bisphenol (di)acrylate derivative, and a (di)acrylate derivative having a thiol group.

8. The optical sheet according to claim 5, wherein the acrylate-based photocurable resin-cured layer is a resin-cured layer, a resin backbone of which has a repeating unit composed of a fluorene diacrylate derivative represented by Formula 1 below: 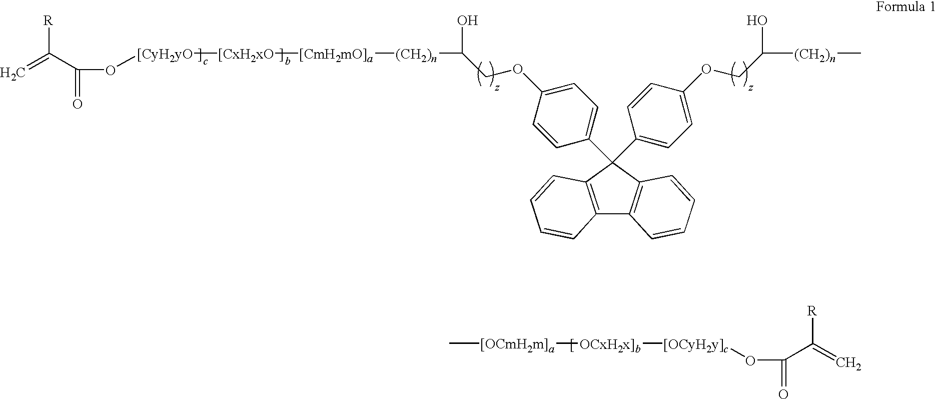
wherein a, b, and c, which are same as or different from each other, are an integer ranging from 0 to 15, n and z, which are same as or different from each other, are an integer ranging from 0 to 15, under a condition of a+b+c+n+z≧1, m, x and y, which are same as or different from each other, are an integer ranging from 0 to 30, in which when a, b and c are not 0, m, x and y which correspond to a, b and c are also not 0, and R is a hydrogen atom or a C1-15 alkyl group.

9. The optical sheet according to claim 6, wherein the cross-linkable derivative comprises a fluorene diacrylate derivative represented by Formula 1 below: 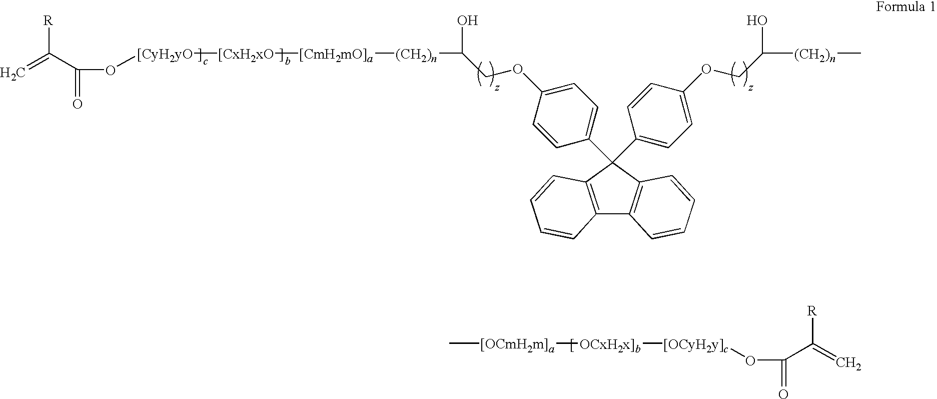
wherein a, b, and c, which are same as or different from each other, are an integer ranging from 0 to 15, n and z, which are same as or different from each other, are an integer ranging from 0 to 15, under a condition of a+b+c+n+z≧1, m, x and y, which are same as or different from each other, are an integer ranging from 0 to 30, in which when a, b and c are not 0, m, x and y which correspond to a, b and c are also not 0, and R is a hydrogen atom or a C1-15 alkyl group.

10. The optical sheet, according to claim 1, wherein the resin-cured layer has a structured surface in which a plurality of three-dimensional structures is linearly or nonlinearly arranged.

11. An optical sheet, comprising a resin-cured layer formed from a liquid composition including a non-halogen cross-linkable derivative and imparted with a structured surface;
wherein, when the structured surface is loaded up to a maximum pressure of 1 gf at a loading rate of 0.2031 mN/sec using a flat indenter, held at the maximum pressure for 5 sec, and then unloaded, the optical sheet has a pressure change rate, represented by Equation 1, below, of 40% or more:
$$Pressure Change Rate = \frac{{D}_{1} - {D}_{2}}{{D}_{1}} \times 100 \qquad Equation 1$$
wherein D1 is a pressed depth due to application of external pressure, and D2 is a difference between a height of the optical sheet before external pressure is applied and a height of the optical sheet returned to an original state after external pressure is removed.

12. The optical sheet according to claim 11, wherein the pressure change rate is 50% or more.

13. The optical sheet according to claim 12, wherein the pressure change rate is 60% or more.

14. The optical sheet according to claim 11, wherein the resin-cured layer is formed from a liquid composition including at least one photocurable acrylate monomer having a viscosity ranging from 1 cps to 50,000 cps at 25° C.

15. The optical sheet according to claim 11, wherein the resin-cured layer has a pencil hardness on its surface of 1H to 3H.

16. The optical sheet according to claim 11, wherein the non-halogen cross-linkable derivative has a refractive index of 1.55 or higher at 25° C.

17. The optical sheet according to claim 11, wherein the non-halogen cross-linkable derivative has a backbone, at least one carbon atom of which is linked with at least two benzene rings and at least one end of which has a cross-linkable unsaturated double bond.

18. The optical sheet according to claim 11, wherein the non-halogen cross-linkable derivative is a fluorene acrylate derivative or a fluorene diacrylate derivative, a backbone of which has a fluorene group.

19. The optical sheet according to claim 14, wherein the photocurable acrylate monomer has a refractive index ranging from 1.44 to 1.55 at 25° C.

20. The optical sheet according to claim 11, wherein the liquid composition has a refractive index of 1.52 or higher at 25° C. and a viscosity ranging from 1 cps to 100,000 cps at 25° C.

21. The optical sheet according to claim 11, wherein the resin-cured layer has a film refractive index of 1.54 or higher at 25° C.

22. The optical sheet according to claim 11, wherein, in the resin-cured layer, an element having 7 valence electrons is absent.

23. The optical sheet according to claim 11, which is manufactured by preparing the liquid composition, comprising the photocurable acrylate monomer including the non-halogen cross-linkable derivative and a photoinitiator and having a viscosity ranging from 10 cps to 100,000 cps and a refractive index of 1.52 or higher;
applying the liquid composition on a frame engraved with three-dimensional structures;
bringing one surface of a transparent substrate film into contact with a surface of the liquid composition applied on the frame, and radiating UV light thereon to cure the liquid composition, thus forming a resin-cured layer; and
separating the resin-cured layer from the frame.

24. A backlight unit assembly, comprising the optical sheet of any one of claim 1.

25. A backlight unit assembly, comprising the optical sheet of claim 11.
